(19) United States
(12) Patent Application Publication
(10) Pub. No.: US 2026/0030067 A1
(43) Pub. Date: Jan. 29, 2026

(54) CONTENTION-AWARE MACHINE LEARNING MODEL SCHEDULING

(71) Applicant: Arm Limited, Cambridge (GB)

(72) Inventors: Joshua Stephan Minor, Austin, TX (US); Shashank Ganapathi Hegde, Austin, TX (US); Michael Bartling, Austin, TX (US)

(21) Appl. No.: 18/784,375

(22) Filed: Jul. 25, 2024

(51) Int. Cl. G06F 9/50

(52) U.S. Cl. CPC G06F 9/5038

(57) ABSTRACT

The present disclosure relates generally to systems, devices and/or processes for scheduling machine learning models within a computing environment.

### BACKGROUND

### Field

The present disclosure relates generally to systems, devices and/or processes for scheduling machine learning models within a computing environment.

### Information

The Internet is widespread. The World Wide Web or simply the Web, provided by the Internet, is growing rapidly, at least in part, from the large amount of content being added seemingly on a daily basis. A wide variety of content in the form of stored signals, such as, for example, text files, images, audio files, video files, web pages, measurements of physical phenomena, and/or the like may be continually acquired, identified, located, retrieved, collected, stored, communicated, etc. Increasingly, content is being acquired, collected, communicated, etc. by a number of electronic devices, such as, for example, embedded computing devices leveraging existing Internet and/or like infrastructure as part of a so-called “Internet of Things” (IoT), such as via a variety of protocols, domains, and/or applications. IoT may typically comprise a system of interconnected and/or internetworked physical computing devices capable of being identified, such as uniquely via an assigned Internet Protocol (IP) address, for example. Devices, such as IoT-type devices, for example, may include computing resources embedded into hardware so as to facilitate and/or support a device's ability to acquire, collect, process and/or transmit content over one or more communications networks. IoT-type devices, for example, may comprise a wide variety of embedded devices, such as, for example, automobile sensors, biochip transponders, heart monitoring implants, thermostats, kitchen appliances, locks or like fastening devices, solar panel arrays, home gateways, controllers, and/or the like.

Additionally, machine learning (ML) is playing an expanding role in the computing industry. A great number of example ML use cases may involve ML inference operations performed on sensor content (e.g., signals and/or signal packets) and/or other content obtained from IoT-type devices and/or other client devices types. Some organizations may provide specialized computing services referred to ML Inference as a Service (IaaS) to address the need for ML computational resources. IaaS may be provided as cloud-based services (e.g., computational tasks performed at one or more cloud servers), as edge-based services (e.g., computational tasks performed at one or more edge nodes) and/or as a combination of cloud-based and edge-based approaches, for example. In some circumstances, IaaS vendors may provide computing services to multiple customers and/or clients, and may therefor execute multiple ML models concurrently. In such circumstances, challenges may be encountered due at least in part to contentions among the multiple ML models as they compete for computing resources, such as, for example, memory bandwidth, central processing unit (CPU) utilization, co-processor and/or accelerator utilization, graphics processor unit (GPU) utilization, etc.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram depicting an embodiment of an example computing environment including one or more server computing devices and/or one or more client computing devices, in accordance with an embodiment;

FIG. 2 is a schematic diagram depicting an embodiment of an example environment for Inference as a Service (IaaS) operations, in accordance with an environment;

FIG. 3 is a schematic block diagraph depicting an example system for scheduling and/or executing ML inference operations, in accordance with an embodiment;

FIG. 4 is a flow diagram depicting an example process for scheduling ML inference operations, in accordance with an embodiment;

FIG. 5 is an example message flow diagram, in accordance with an embodiment; and

FIG. 6 depicts a schematic diagram illustrating an implementation of an example computing and/or communications environment, in accordance with an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned, machine learning (ML) is playing an expanding role in the computing industry. A great number of example ML use cases may involve ML inference operations performed on sensor content (e.g., signals and/or signal packets) and/or other content obtained from IoT-type devices and/or other client devices types. Some organizations may provide specialized computing services referred to ML Inference as a Service (IaaS) to address the need for ML computational resources. IaaS may be provided as cloud-based services (e.g., computational tasks performed at one or more cloud servers), as edge-based services (e.g., computational tasks performed at one or more edge nodes) and/or as a combination of cloud-based and edge-based approaches, for example. In some circumstances, IaaS vendors may provide computing services to multiple customers and/or clients, and may therefor execute multiple ML models concurrently. In such circumstances, challenges may be encountered due at least in part to contentions among the multiple ML models as they compete for computing resources, such as, for example, memory bandwidth, central processing unit (CPU) utilization, co-processor and/or accelerator utilization, graphics processor unit (GPU) utilization, etc.

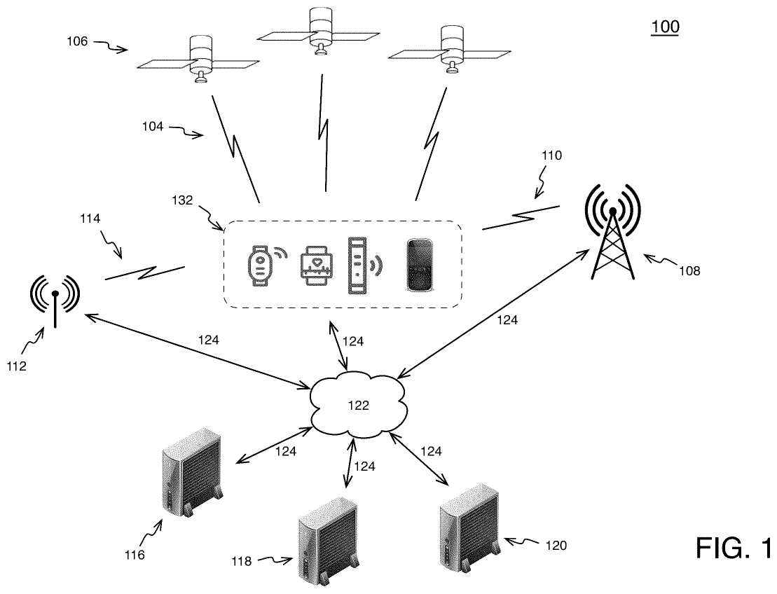

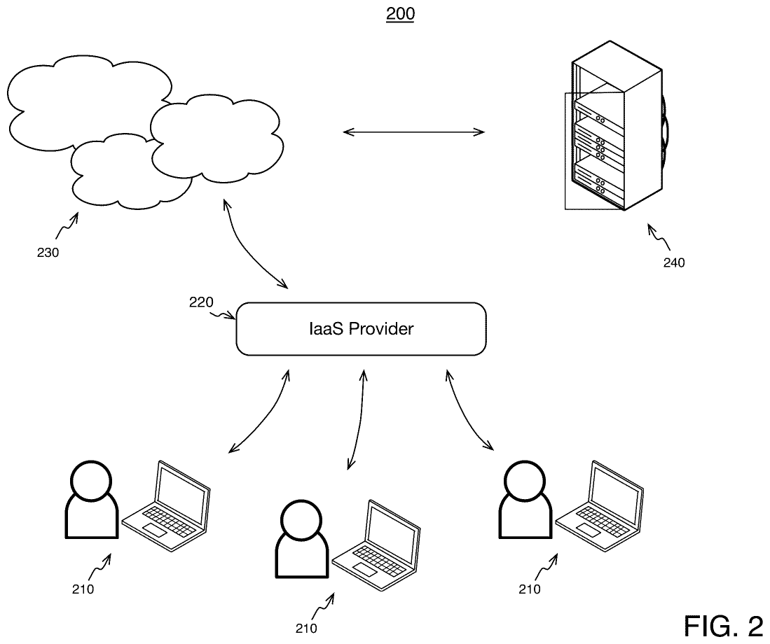

Embodiments may be implemented, at least in part, within an example environment described below in connection with FIG. 1 and/or FIG. 2. Of course, subject matter is not limited in scope in these respects.

FIG. 1 is a schematic diagram illustrating features associated with an implementation of an example operating environment 100 capable of facilitating and/or supporting one or more operations, processes, techniques, approaches, etc. for contention-aware machine learning (ML) model scheduling. It should be appreciated that operating environment 100 is described herein as a non-limiting example that may be implemented, in whole or in part, in a context of various wired and/or wireless communications networks and/or any suitable portion and/or combination of such networks. For example, these or like networks may include one or more public networks (e.g., the Internet, the World Wide Web), private networks (e.g., intranets), wireless wide area networks (WWAN), wireless local area networks (WLAN, etc.), wireless personal area networks (WPAN), telephone networks, cable television networks, Internet access networks, fiber-optic communication networks, waveguide communication networks and/or the like. It should also be noted that claimed subject matter is not limited to a particular network and/or operating environment. Thus, for a particular implementation, one or more operations, processes, techniques, approaches, etc. for sharing machine learning models may be performed, at least in part, in an indoor environment and/or an outdoor environment, or any combination thereof.

Thus, as illustrated, in a particular implementation, one or more client computing devices 132, such as IoT-type devices, may, for example, receive and/or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems, for example. In certain implementations, SPS satellites 106 may be from any one several regional navigation satellite systems (RNSS) such as, for example, WAAS, EGNOS, QZSS, just to name a few examples.

At times, one or more client computing devices 132 may, for example, transmit wireless signals to and/or receive wireless signals from a suitable wireless communication network. In one example, one or more client computing devices 132 may communicate with a cellular communication network, such as by transmitting wireless signals to and/or receiving wireless signals from one or more wireless transmitters capable of transmitting and/or receiving wireless signals, such as a base station transceiver 108 over a wireless communication link 110, for example. Similarly, one or more client computing devices 132 may transmit wireless signals to and/or receive wireless signals from a local transceiver 112 over a wireless communication link 114, for example. Base station transceiver 108, local transceiver 112, etc. may be of the same or similar type, for example, and/or may represent different types of devices, such as access points, radio beacons, cellular base stations, femtocells, an access transceiver device, or the like, depending on an implementation. Similarly, local transceiver 112 may comprise, for example, a wireless transmitter and/or receiver capable of transmitting and/or receiving wireless signals. For example, at times, wireless transceiver 112 may be capable of transmitting and/or receiving wireless signals from one or more other terrestrial transmitters and/or receivers.

In a particular implementation, local transceiver 112 may, for example, be capable of communicating with one or more client computing devices 132 at a shorter range over wireless communication link 114 than at a range established via base station transceiver 108 over wireless communication link 110. For example, local transceiver 112 may be positioned in an indoor or like environment and/or may provide access to a wireless local area network (WLAN, e.g., IEEE Std. 802.11 network, etc.) and/or wireless personal area network (WPAN, e.g., Bluetooth® network, etc.). In another example implementation, local transceiver 112 may comprise a femtocell and/or picocell capable of facilitating communication via link 114 according to an applicable cellular or like wireless communication protocol. Again, it should be understood that these are merely examples of networks that may communicate with one or more client computing devices 132 over a wireless link, and claimed subject matter is not limited in this respect. For example, in some instances, operating environment 100 may include a larger number of base station transceivers 108, local transceivers 112, networks, terrestrial transmitters and/or receivers, etc.

In an implementation, one or more client computing devices 132, base station transceiver 108, local transceiver 112, etc. may, for example, communicate with one or more servers, referenced herein at 116, 118, and 120, over a network 122, such as via one or more communication links 124. Network 122 may comprise, for example, any combination of wired and/or wireless communication links. In a particular implementation, network 122 may comprise, for example, Internet Protocol (IP)-type infrastructure capable of facilitating or supporting communication between one or more client computing devices 132 and one or more servers 116, 118, 120, etc. via local transceiver 112, base station transceiver 108, directly, etc. In another implementation, network 122 may comprise, for example cellular communication network infrastructure, such as a base station controller and/or master switching center, to facilitate and/or support mobile cellular communication with one or more client computing devices 132. Servers 116, 118 and/or 120 may comprise any suitable servers or combination thereof capable of facilitating or supporting one or more operations, processes, techniques, approaches, etc. discussed herein. For example, servers 116, 118 and/or 120 may comprise one or more update servers, back-end servers, management servers, archive servers, location servers, positioning assistance servers, navigation servers, map servers, crowdsourcing servers, network-related servers, or the like.

Also, in embodiments, servers 116, 118, and/or 120 may be utilized to implement, at least in part, an inference as a service (IaaS) system. For example, IoT-type devices 132 may request inference computation services from an IaaS system comprising one or more of servers 116, 118, and/or 120. Such operations are explained more fully below.

Even though a certain number of computing platforms and/or devices are illustrated herein, any number of suitable computing platforms and/or devices may be implemented to facilitate and/or support one or more operations, processes, techniques, approaches, etc. associated with operating environment 100. For example, at times, network 122 may be coupled to one or more wired and/or wireless communication networks (e.g., WLAN, etc.) so as to enhance a coverage area for communications with one or more client computing devices 132, one or more base station transceivers 108, local transceiver 112, servers 116, 118, 120, or the like. In some instances, network 122 may facilitate and/or support femtocell-based operative regions of coverage, for example. Again, these are merely example implementations, and subject matter is not limited in this regard.

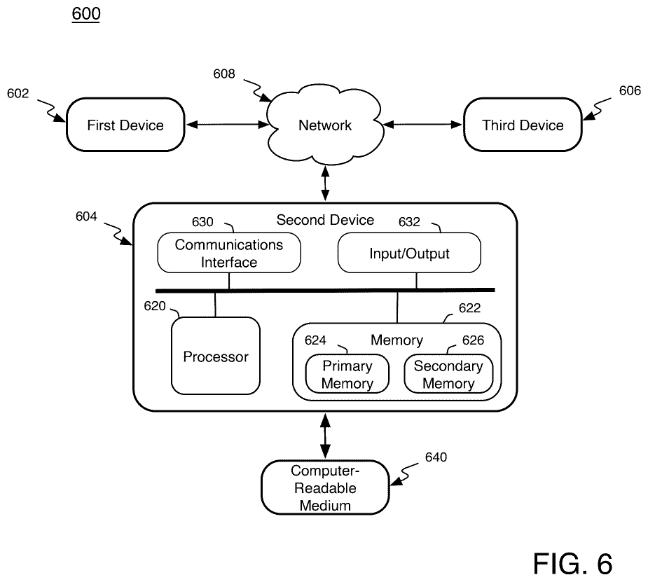

In this context, “IoT-type device” and/or the like refers to one or more electronic and/or computing devices capable of leveraging existing Internet or like infrastructure as part of the so-called “Internet of Things” or IoT, such as via a variety of applicable protocols, domains, applications, etc. As was indicated, the IoT is typically a system of interconnected and/or internetworked physical devices in which computing may be embedded into hardware so as to facilitate and/or support devices' ability to acquire, collect, and/or communicate content over one or more communications networks, for example, at times, without human participation and/or interaction. Client computing devices 132, which may, for example, include one or more IoT-type devices, may include a wide variety of stationary and/or mobile devices, such as, for example, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, notebook computers, personal entertainment systems, tablet devices, personal computers (PCs), personal audio and/or video devices, personal navigation devices, and/or the like, to name a few non-limiting examples. Typically, in this context, a “mobile device” and/or the like refers to an electronic and/or computing device that may from time to time have a position or location that changes. “Stationary device” and/or the like refers to a device that may have a position or location that generally does not change. In some instances, client computing devices 132, such as IoT-type devices, may be capable of being identified, such as uniquely, via an assigned Internet Protocol (IP) address, as one particular example, and/or having an ability to communicate, such as receive and/or transmit electronic content, for example, over one or more wired and/or wireless communications networks. In implementations, servers 116, 118, and/or 120 and/or IoT-type devices 132 may share at least some attributes and/or characteristics with computing device 604 depicted in FIG. 6, for example, although subject matter is not limited in scope in these respects.

FIG. 2 depicts an embodiment of an example environment 200 for Inference as a Service (IaaS)-type operations. In implementations, IaaS provider 220 may provide an interface by which client devices 210 may access machine-learning (ML)-type computing resources that may be utilized to perform ML related inference operations. For example, one or more ML models may be provided to IaaS provider 220 by one or more businesses, organizations, entities, customers, etc., and the ML models may be executed at least in part via cloud computing resources 230 and/or data centers 240. IaaS provider 220 may interact with client devices (e.g., IoT-type devices) 210, wherein applications executed at client devices 210 may communicate with IaaS provider 220 to have ML-type operations performed in connection with the ML models provided to IaaS provider 220 by the aforementioned businesses, organizations, entities, customers, etc., for example. Embodiments discussed herein may be directed to challenges that may be encountered due to contentions among multiple ML models residing on IaaS 220, for example, as the various ML models compete for computing resources (e.g., memory bandwidth, CPU utilization, co-processor and/or accelerator utilization, GPU utilization, etc.).

For example, embodiments may be directed to addressing issues related to executing multiple ML models concurrently more efficiently (e.g., as efficiently as possible) on a variety of disparate and/or heterogeneous processing elements. IaaS platforms, such as IaaS provider 220, may provide customers the ability to load multiple instances of an inference model into memory, to select where the model should run (e.g., CPU, GPU, Neural Processing Unit (NPU), etc.), and/or may dynamically batch requests for ML inference operations from client devices, such as client devices 210, to improve performance. In circumstances, it may be difficult to predict when requests may be received from clients. Also, for example, requests from clients for ML inference operations may come in bursts, wherein a number of requests may be received over a shorter period of time followed by a period with relatively fewer requests.

To address such challenges, embodiments may be directed at managing, at least in part, contention for shared computing resources when multiple ML models are executed concurrently, for example. In an embodiment, an apparatus may comprise a forecaster circuit of an inference as a service (IaaS) system to generate a predicted timing distribution for a plurality of expected inference requests for a plurality of machine-learning (ML) models to be concurrently executed at the IaaS, and may also comprise a scheduler circuit of the IaaS to, responsive at least in part to one or more inference requests obtained from one or more clients, schedule execution of a plurality of compute nodes of a subset of the plurality of ML models based at least in part on the predicted timing distribution for the plurality of expected inference requests for the plurality of ML models.

Also, in embodiments, an example process may comprise generating, by a forecaster circuit of an inference as a service (IaaS) system, a predicted timing distribution for a plurality of expected inference requests for a plurality of machine-learning (ML) models to be concurrently executed at the IaaS system, and may further comprise, responsive at least in part to one or more inference requests obtained from one or more clients, scheduling, by a scheduler circuit of the IaaS system, execution of a plurality of compute nodes of a subset of the plurality of ML models based at least in part on the predicted timing distribution for the plurality of expected inference requests for the plurality of ML models.

Further, embodiments may comprise a non-transitory computer-readable medium having stored thereon one or more instructions executable by one or more computing devices of an IaaS system to generate a predicted timing distribution for a plurality of expected inference requests for a plurality of machine-learning (ML) models to be concurrently executed at the IaaS system, and to, responsive at least in part to one or more inference requests obtained from one or more clients, schedule execution of a plurality of compute nodes of a subset of the plurality of ML models based at least in part on the predicted timing distribution for the plurality of expected inference requests for the plurality of ML models.

As mentioned, embodiments may be directed at managing, at least in part, contention for shared computing resources when multiple ML models are executed concurrently, for example. In implementations, ML models may be represented as Directed Acyclic Graphs (DAGs) wherein the shape of input tensors, corresponding operations, and architecture of individual DAGs may be known. Nodes of a graph, such as a DAG, may represent operations to be performed on input data, for example. In the discussion that follows, nodes representing operations to be performed on input data may be referred to as “compute nodes.” Further, edges of a graph, such as a DAG, may represent data that may be fed to compute nodes, in implementations.

As utilized herein, the terms “compute node” and “kernel” are synonymous, and may be used interchangeably. Similarly, the terms “graph” and “model” may be utilized interchangeably. In general, for consistency of explanation, the terminology of “compute node” and “model” (e.g., ML model) may be used in the discussion that follows.

Embodiments may be directed to determining (and/or utilizing) more efficient (e.g., most efficient) scheduling for mapping ML model nodes on processing elements, for example, that may improve (e.g., maximizes) throughput and/or that may reduce (e.g., minimize) computational resource contention. For example, embodiments may include an approach for scheduling ML inference workloads with awareness of multiple (e.g., all) models being executed, wherein the approach may include dynamically reordering a priority order for a sequence of operations (e.g., compute nodes) based, at least in part, on one or more heuristics representative of resource contention within a system, such as IaaS provider 220 and/or IaaS system 300 discussed below.

Also, for example, embodiments may include a forecasting framework to exploit inference request dynamics and/or to allow a scheduler to forgo computationally expensive contention measurements at least in part by “guessing” at costs involved and/or to speculate on future scheduling. For example, embodiments may include an approach to encoding snapshots of ML model scheduling that may improve quality of measurements and/or may allow for approximate similarity searches, as explained more fully below. Also, in implementations, a global queue may be utilized through which ML model compute nodes (e.g., nodes within a computational graph, such as a DAG) may be scheduled.

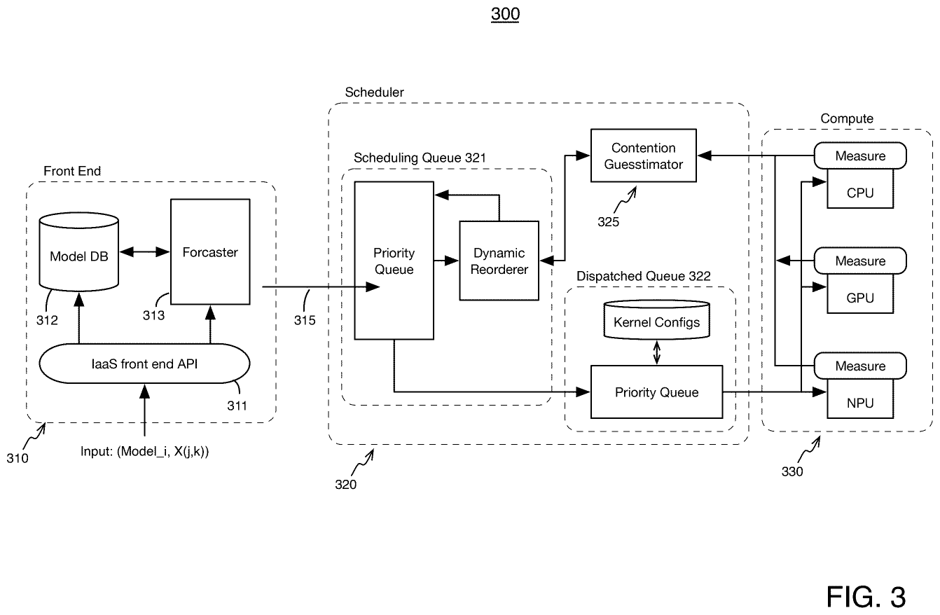

FIG. 3 is a schematic block diagraph depicting an example system 300 for scheduling and/or executing ML inference operations, in accordance with an embodiment. In implementations, system 300 may include front end 310, scheduler 320, and/or compute unit 330, for example. Front end 310 may receive inputs representative of ML models (e.g., DAGs) at an IaaS front end API 311, wherein the shape of input tensors and/or architecture of the ML models may be known. As indicated, multiple ML models may be stored in a model database 312 of front end 310. Front end 310 may also include a forecaster circuit 313, as shown. Of course, subject matter is not limited in scope in these respects.

In implementations, multiple sources of information may be utilized to make scheduling decisions. For example, basic heuristics on the execution of individual target compute nodes (e.g., kernels) may be gathered which may be represented as a cost. See relation 1, provided and discussed below, for one such example heuristic. Also, for example, individual ingested ML models (e.g., DAGs) may be analyzed for data dependencies that may not be exploited at earlier stages, such as in offline graph optimization operations, for example, in addition to building an estimate (e.g., best “guess”) of an initial scheduling. In implementations, a scheduling system, such as example system 300, may process such statistics, knowledge about each ML model, and/or measurements from the execution environment to improve (e.g., maximize) throughput and/or reduce (e.g., minimize) expected computational cost. That is, for example, a predicted timing distribution for a plurality of expected inference requests may be generated, such as by forecaster 313, in implementations. “Timing distribution” and/or the like in this context refers to one or more signals and/or states representative of timing content pertaining to inference requests. “Predicted timing distribution” and/or the like in this context refers to one or more signals and/or states representative of predicted timings for expected inference requests. In implementations, a predicted timing distribution may comprise individual predicted timings for expected inference requests for individual ML models of one or more ML models. In other implementations, a predicted timing distribution may comprise an overall distribution describing predicted timings for expected inference requests for multiple ML models.

For ease of explanation, it may be assumed that incoming inference requests, such as may be received from clients 210 at IaaS front end API 311, may be independent in nature. For example, object detection followed by image classification may be rolled into one ML model fed to IaaS front end 310. Under these example conditions, the incoming requests may be modeled, such as by forecaster 313, as a Poisson process, for example, meaning that known probability distributions may be assigned to individual ML models, parameters may be estimated on the fly, and/or the distributions may be sampled to estimate (or “guess”) when the next inference request may be received (e.g., from client devices 210), in implementations. As long as likely parameters associated with the measured events fall within a threshold, it may be assumed that the scheduling system is experiencing expected operating behaviors and/or that the performance characteristics of the currently running ML models may likely align with samples that have occurred in the past.

More particularly, forecaster 313, for example, may model incoming requests as a random number of requests in a fixed amount of time (e.g., Poisson distribution) and/or as a random amount of time before a fixed number of requests are received (e.g., Erlang distribution). In implementations, an Erlang distribution may conceptually be the easiest. For example, as if the parameter for the number of requests is set to 1, the formula becomes a simple exponential decay function parameterized by time, conditioned on current observations. Stated otherwise, responsive to each new inference request received from clients 210 at IaaS front end API 311, for example, it may be estimated (“guessed”) which models will come next and, approximately, at what times, for example.

In implementations, a set of available processing elements, such as hardware processing elements of compute unit 330, that are available for computing intermediate values of a DAG may be determined and/or stored. In implementations, compute unit 330 may include one or more CPUs, one or more GPUs, and/one or more NPUs, for example. Of course, subject matter is not limited in scope in these respects. System 300 may also determine and/or store a set of known, configured compute nodes that may operate relative to, and/or represent the computations of, compute nodes of an ML model (e.g., DAG), for example. As also depicted in compute unit 330, measurement instrumentation may be included to generate inference request statistics for contention estimation, in implementations. Example measurements may include, by way of non-limiting examples, compute latency, memory bandwidth, intermediate tensor memory footprint, time from last inference, etc.

In implementations, scheduler 320 may include a contention guesstimator 325. Although the terms “guess,” “guesstimator” and/or the like are utilized herein, such terms are not meant to denote uninformed guesses. Rather, estimates related to ML computational resource contention and/or scheduling, for example, may be made based at least in part on a variety of information, in implementations. Scheduler 320 may further include a scheduling queue 321 and a dispatched compute nodes (e.g., kernels) queue 322, for example. Of course, embodiments of system 300 may comprise arrangements of functional units that differ from that shown in FIG. 3, and subject matter is not limited in scope in these respects.

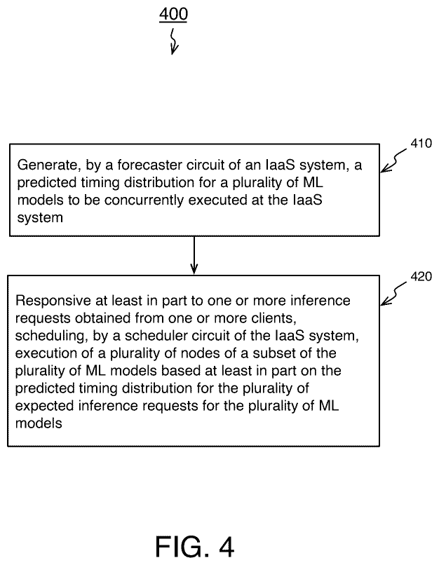

FIG. 4 is a flow diagram illustrating an embodiment of an example process 400 for scheduling ML inference operations. Embodiments in accordance with claimed subject matter may include all of blocks 410-420, fewer than blocks 410-420, and/or more than blocks 410-420. Likewise, it should be noted that content acquired or produced, such as, for example, input signals, output signals, operations, results, etc. associated with example process 400 may be represented via one or more digital signals. It should also be appreciated that even though one or more operations are illustrated or described concurrently or with respect to a certain sequence, other sequences or concurrent operations may be employed. In addition, although the description below references particular aspects and/or features illustrated in certain other figures, one or more operations may be performed with other aspects and/or features. In embodiments, blocks 410-420 may be communicated as one or more signals and/or signal packets among various software, firmware and/or hardware services executed at IaaS system 300, for example.

The discussion related to example process 400 may be considered in connection with IaaS system 300, for example. In at least some respects, example process 400 may represent a generalized explanation of some of the features, attributes, and/or functions of IaaS system 300, in an embodiment. Of course, subject matter is not limited in scope in these respects.

As depicted at block 410, a predicted timing distribution for a plurality of ML models to be concurrently executed, such as at compute unit 330, may be generated, such as by forecaster 313, in implementations. A more detailed discussion related to inference operation forecasting, predicting timing distributions for expected incoming inference requests, and so forth is provided below, in additional to the discussion above.

As further shown at block 420, execution of a plurality of compute nodes of a plurality of ML models may be scheduled responsive, at least in part, to one or more ML inference requests obtained from one or more clients, such as clients 210, for example. In implementations, and as explained more fully below, the scheduling of the compute nodes for execution may be based, at least in part, on the predicted timing distribution for the plurality of expected ML inference requests for the plurality of ML models, for example.

As mentioned, further details related to example operations, functions, attributes, etc. related to IaaS system 300 are provided below. System 300, for example, may include “measurement” and/or “forecasting” modes of operation. For example, a measurement mode of operation may comprise a compute scheduler, such as scheduler circuit 320, tailored IaaS operation. In implementations, individual ML inference request access statistics may be captured. That is, separate statistics may be captured, generated, calculated, measured, etc., for each individual ML model. As mentioned, an IaaS system may execute multiple ML models at any given time, in implementations. Also, for example, at a given point in time, compute nodes (e.g., “kernels to run”) may be scheduled via push operations, for example, from forecaster 313 to a priority queue of scheduling queue 321. At scheduling queue 321, compute nodes may be dynamically assigned a priority based at least in part on topographical orderings and/or on computational resource contention estimates. In implementations, contention estimates may be determined, at least in part, by querying contention guesstimator 325 and/or by analyzing attributes associated with individual compute nodes (e.g., I/O tensor shapes and/or date types, indications of whether a compute node may be compute bound or memory bound, etc.). Additionally, compute nodes in an ML model (e.g., DAG) may include colorings, where compute nodes and/or subgraphs of the same color may represent parallel operations that may occur in any order, for example. That is, for example, compute nodes of a similar color may have no data dependencies between them and may be executed concurrently. Further, scheduler 320 may assign desired processing elements (e.g., elements of compute unit 330) for individual compute nodes, in an implementation.

In a measurement mode of operation (e.g., full measurement mode), responsive, at least in part, to processing elements becoming available for computation, dispatched queue 322 may be notified, for example. In implementations, dispatched queue 322 may obtain compute nodes from scheduling queue 321. Dispatched queue 322 may keep track of running compute nodes and/or their intermediate tensors and/or may inject measurement configurations. In implementations, a sum of contention measurements for a running set of compute nodes may be referred to as the system pressure.

In implementations, contention measurements and/or system pressure estimates relative to a current scheduling snapshot may be captured in contention guesstimator 325, for example. Implementations may include a FIFO queue per compute node and/or a randomly sampled array of measurements per compute node, for example. Other implementations may leverage ML on compute node queries, for example.

As mentioned, system 300 may include a forecasting mode of operation. In circumstances, constantly and/or continuously running measurements may be expensive from a computational resource perspective. Further, dynamically scheduling compute nodes as discussed above may introduce undesired latency. In implementations, rather than incurring these costs, scheduler 320 may forward predict the next likely inference requests and/or may further predict roughly when they will occur. Scheduler 320 may further speculatively schedule the incoming inference requests based at least in part on the history captured in contention guesstimator 325, for example.

For an example forecasting mode of operation for system 300, it may be assumed that the inference requests for K models are independent in nature, in implementations. Parameters for K Erlang distributions may be estimated and/or timers may be instructed to start counting responsive at least in part to a target event inference, for example. Additionally, such probabilities may include a Bayesian update operation responsive to an inference request to readjust the expected amount of time until the next estimated inference request will arrive, in implementations.

Further, in implementations, while in forecasting mode, it may be beneficial to introduce some measurement requests to account for the limited search space that may be available for guesstimator training. Such requests may be sampled at random, for example. Further, in implementations, contention guesstimator 325 may continue to capture access statistics for individual ML models. In the event that one or more of the access statistics for individual ML models start to diverge from the estimated parameters in their corresponding distributions, the assumptions for the guesstimators may no longer be valid, and measurements may be rerun in a measurement mode for a period of time. In circumstances, there may be samples that may potentially run out of distribution. That is, their expected times may not be accounted for in a model, so in these circumstance it may be beneficial to run instrumentation. In implementations, such samples may be relatively easy to measure because the expected distribution may be an exponential form, for example.

In implementations, a contention estimator, such as contention guesstimator 325, may leverage ML-based approaches and/or may utilize relatively simple statistical metrics based at least in part on current compute nodes in dispatched queue 322, for example. In implementations, a convolutional neural network (CNN) may be utilized to predict the efficacy of scheduling a crest from a wave (e.g., plurality of expected inference requests) given a current load on system 300 and/or given characteristics of currently running compute nodes in scheduling queue 321. This model may take in the parameters of the N compute nodes in the candidate crest starting from the head of the priority queue and/or may estimate the contention implications of scheduling it. From among the candidate running queues, a running queue having the lowest predicted contention and/or the largest packing of compute nodes may be selected.

Other implementations for contention estimation, such as via contention guesstimator 325, may utilize reinforcement learning (RL). The CNN approach mentioned above may predict performance for individual candidates in scheduling queue 321. In a RL approach, ordering and/or prediction estimates may be coupled so that the error margin may improve in a highly dynamic system, for example. In implementations, a reward function may estimate how well a given selection of schedulable candidates may reduce contention.

In implementations, another approach for contention estimation, such as via contention guesstimator 325, may include integer programming. This approach may take in several low-level parameters such as performance counter estimates for running individual compute nodes, size, and/or dimension of the compute node input and/or outputs. In implementations, the integer programming approach may include solving a non-linear quadratic problem and/or may provide hints to the selection so that the ordering on the compute nodes may be based on the solver estimates, for example.

For contention estimation, such as via contention guesstimator 325, a coloring of individual ML models (e.g., DAGs) may be performed ahead of time based at least in part on data dependencies as encoded in the structure of the ML model, for example. In implementations, compute nodes may be colored similarly if they have no dependencies and/or may be assigned a different color otherwise. Such an example coloring scheme may be utilized when pulling compute nodes from the execution queues of each of the ML models into the wave. In an implementation, the coloring of compute nodes may be utilized to relatively quickly decide how many compute nodes from the head of each queue can be pulled such that there are no data dependencies, for example. In another implementation in which there may be no assumption of no data dependencies, a coloring scheme may be utilized to pull multiple compute nodes from a model's execution graph which do have a data dependency. In such an implementation, an optimization may be performed to issue dependent compute nodes one after the other such that the result of the first compute node resides in cache when the second is executed. Such an approach may reduce (e.g., minimize) memory traffic, for example.

Example embodiments related to contention estimation discussed herein may find advantageous use in a wide range of circumstances. Such approaches may be advantageously implemented for any of a wide range of systems from smaller systems to larger server systems. For example, scheduling operations involving contention estimation such as described herein may be utilized in larger distributed systems for intelligent scheduling of ML based workloads. Further, some devices may be resourced constrained, and understanding how to distribute compute operations for a set of ML models across a number of processing elements, such as compute units 330, may be a key to enabling larger scale systems which may dynamically adapt workloads to fit the needs of clients requesting ML inference operations (e.g., via IaaS front end 310).

In another embodiment, a cloud service provider may host a service which may provide managed runtime for ML models, and the service provider may desire to achieve improved (e.g., greater, greatest, etc.) throughput across all served ML models. Utilizing example approaches to contention estimation described herein for an ML inference scheduling system, such as example system 300, contention for shared resources, such as DRAM memory controller allocations, for example, may be reduced (e.g., minimized), thereby increasing aggregate throughput. An example use case may include autonomous vehicle navigation, as multiple computer vision models may execute concurrently, and latency and/or throughput may be improved (e.g., optimized) to make real-time control decisions, for example.

In implementations, contention estimation, such as operations that may be performed by contention guesstimator 325, for example, may be performed in accordance with the example relation 1 provided below.

$$= f ( {S}_{k}^{i ..} , {S}_{k}^{o} , \vert {Sp}_{t} ) \qquad ( 1 )$$

wherein

represents a contention estimate of compute node (e.g., kernel) k, at time t, wherein

$${S}_{k}^{i}$$

represents a size of the inputs to the compute node (e.g., weights, inputs, bias, etc.), and wherein Spₜ represents a system pressure comprising utilization estimates for multiple resources (e.g., estimate of all the resource utilization estimates). For example, system pressure may be determined in accordance with example relation 2, provided below.

$${Sp}_{t} ← {\sum }_{d} {g}_{d} ( {M}_{t , class ...}^{d} , {C}_{t}^{d} ) \qquad ( 2 )$$

In an implementations, a compute node having a latency of less than 1 us, for example, may be grouped with a head compute node, although subject matter is not limited in scope in these respects.

The example approaches, embodiments, and/or implementations discussed above may discuss a part of an overall system. For example, embodiments may describe estimating the efficacy of a wave and/or a corresponding schedule. However, in embodiments, individual compute nodes (e.g., kernels) may be stored, reordered, and/or dispatched. Several approaches for storing, reordering, and/or dispatching compute nodes are discussed below.

For example, an approach may include automatic reordering of a priority queue, such as the priority queue of scheduling queue 321. In implementations, a schedule may be adjusted based at least in part on a shift in resource requirements of a current system state even after a schedule has been built for a wave (e.g., plurality of expected inference requests). Further, in implementations, the priority queue may be reordered responsive at least in part to individual tasks being pulled from the queue, for example. This example approach may lead to a more dynamic system, although the impact on system overhead may be considered.

Further implementations may include multiple dispatch queues. For example, based at least in part on system state estimates, schedulable compute nodes may be placed into one or more of multiple queues that may have set priorities of their own. For example, implementations may include a memory-bound-queue, a compute-bound-queue, and/or network-bound-queue, in implementations. Of course, subject matter is not limited in scope in these respects.

Additional implementations may include ping-pong queues. For example, implementations may include a compute-bound-queue and a memory-bound-queue, wherein the individual queues may be advanced based at least in part on current system contention and/or health, for example. The ping-pong approach may be viewed as a special case of the multiple dispatch queue approach mentioned above.

Above, example embodiments of measurement and/or forecasting modes of operation, such as for IaaS system 300, are discussed. In other embodiments, “contention guesstimator training” and/or “dynamic operation fusion” modes of operation may also be implemented, for example.

For a contention guesstimator training mode of operation, for example, it may be noted that implementations may deal with constructions of relatively small inference ML models. For example, ML models may comprise a set of higher level operations (e.g., compute nodes) and/or a set of intermediary tensors (e.g., edges) encoding dependency in the edge directionality. In implementations, part of scheduler 320's goal may be to map such operations to lower level compute nodes to run on processing elements, such as those of compute unit 330, in a way the reduces contention and/or improves throughput.

As at least a partial result of the potentially relatively very large number of combinations of a dispatched set of compute nodes and their runtime configurations, attempts to directly index a cache of contention guesstimator 325, for example, may involve a tradeoff of index size vs. quality vs. noise in the history, for example. However, due at least in part to such properties, some ML inference use cases may be tweaked for similarity search in ranking and/or for approximate nearest neighbors search, which may be performed unsupervised and/or online during execution, for example.

For example, assume that a target model is LSH (locality sensitive hashing)+Minhashing (note there may be many projection methods and/or hashing approaches available). The example model may assume that if the data is hashed a number of times, detected collisions may imply similarity in the data, for example. In implementations, if the hash functions are grouped on the queried documents (e.g., group of queries) in a particular (e.g., smart) fashion, set similarity may be approximated for essentially the price of a few hashes (see minhash+Jaccard Similarity for example).

For contention guesstimator training, in implementations, an approach may include counting the number of unique meta operations supported (e.g., depthwise convolution 2D) and/or the number of available compute nodes for each of these classes (e.g. depthwise_conv_2d_neon_v4). Individual compute nodes (e.g., each kernel) may be assigned a unique ID (generally counting up from 0) where similar operation classes numbers are nearby, for example. In implementations, the actual function for assigning these values may not matter as long as rough groups are maintained. Alternatively, for example, groupings may be treated as separate column vectors, although, again, this may not alter the interpretation.

In implementations, contention guesstimator training may further include, for a given group of compute nodes to run from dispatched queue 322 (or scheduling queue 321 for queries), instead of using N-grams of these values over time, as may be done in other circumstances, the present approach may utilize the physical connectivity of these compute nodes as specified in the various ML models as a sparse one-hot-encoding, for example, of the operation transitions. Additionally, in implementations, self-loops may be inserted for each compute node running so these compute nodes are not missed. A flattened version of this adjacency matrix for the “running” subgraphs may comprise document query, for example.

Further, the present approach for contention guesstimator training may proceed with a minhashing of the queries into a dense signature (e.g., number of elements may comprise a hyperparameter) followed by band hashing these signatures (e.g., run k hash functions on chunks of the dense signature, also a hyperparameter), for example. Also, in implementations, band hashed values may be utilized to index a hash table. Further, caching measurements may be similar to inserting their metadata at buckets in the hash table and/or querying may be the opposite of reading the data stored at each hashed bucket, for example. Because multiple (k) hash functions may be utilized per document query into this hash table, the quality of our query of document D may be weighted as w=k′/k where k′ represents the number of hash collisions encountered, in implementations. Additionally, the present approach for contention guesstimator training may include aggregating/collating the resulting metadata, and/or may include potentially reweighting with a query quality factor, as the contention estimates/system pressure guesstimates for scheduler 320, for example.

System 300 may also include a dynamic operator fusion mode of operation, as mentioned. In implementations, ML models may contain thousands of operations in their DAGs, for example. To simplify things for scheduler 320, for example, operations may be intelligently clustered together so as to increase the size of the quanta for scheduler 320 and/or to further reduce scheduling overhead. Such an approach may be seen as changing the scheduler's resolution, for example.

To perform such a grouping, a number of approaches may be utilized. For example, operations may be grouped ahead of time knowing the structure of the ML model (e.g., DAG). A clustering algorithm may be applied to create as many equal sized groups as possible given a max group size. In implementations, this may be done via graph partitioning and/or a simple cost function, for example. Also, for example, operations may be grouped using existing co-issuing patterns for operations that the scheduler has performed in the past. That is, for example, if it is observed that a group of operations typically are scheduled together, a single super operation may be generated and its scheduling may be considered. This approach may leverage some of the encodings gained in contention guesstimator 325, in implementations. Further, for example, at a given schedule horizon, scheduler 320 may choose to group compute nodes of the graph in a “greedy” fashion until system 300 can accommodate based, at least in part, on current system pressure.

The discussion above is centered on approaches for contention-aware scheduling for concurrent ML model execution for IaaS systems, wherein histories of measured contention for a given set of operations may be leveraged. The discussion that follows is directed to approaches for the confidential scheduling of IaaS operations, wherein an execution model may be blind to the operations and/or data, and also leveraging a secure enclave-based architecture covering a diverse set of processing elements (e.g., compute units 330). “Enclave” and/or the like in this context refers to additional security mechanisms that may be introduced to some processor architectures to provide additional support for confidential computing, for example. A secure enclave-based architecture may introduce a security state that may be referred to as a “enclave” state to operate alongside existing privilege levels, in implementations.

In circumstances, a ML model's learned weights and/or input data may be proprietary to mutually untrusting users of an IaaS platform. A scheduling mechanism with no obfuscating of data, perhaps similar in some respects to embodiments and/or implementations described above, may be subject to data piracy by either an external adversary and/or by the IaaS provider itself, for example. As one aspect of addressing this potential issue, secure enclaves may provide hardware level isolation for application code and/or data from anyone with privileges via memory encryption, in implementations.

For circumstances in which multiple inference requests may be executed for some subset of ML models received (e.g., received at IaaS front end 310) at random intervals, for example, embodiments may be directed to effectively scheduling pluralities of obfuscated/hidden elements and/or may be directed to determining more efficient (e.g., most efficient) scheduling for mapping obfuscated compute nodes on processing elements that may improve (e.g., maximize) throughput and/or reduce (e.g., minimize) system contention.

In embodiments, ML inference workloads may be scheduled at a compute node (e.g., kernel) granularity without awareness of models (e.g., all models) being executed in the system (e.g., system 300), for example. Also, in implementations, an issue sequence of operations may be dynamically reordered based at least in part on one or more heuristics.

In implementations, a “blinded” optimizer (e.g., implemented within system 300 utilizing one or more of the functional units depicted in FIG. 3) may utilize one or more sources of information on which it may make decisions and may do so without obtaining or storing content specifying the source of a compute node (e.g., kernel) and/or the data the compute node is operating on. For example, in a manner similar in at least some respects to what has been explained previously in connection with other embodiments, basic heuristics on the execution of individual target compute nodes may be gathered which may be represented as a cost. Also, for example, individual ingested ML models may be analyzed for data dependencies not exploited at earlier stages, such as in offline graph optimization operations, in addition to building an estimate (e.g., best “guess”) of an initial scheduling. In implementations, ML models may have relatively very static execution behaviors. However, when considering multiple models running concurrently, call statistics for individual ML models may vary quite a lot in some circumstances. In implementations, a scheduling system, such as example scheduler 320, may process these statistics, knowledge about each model, and/or measurements from the execution environment to improve (e.g., maximize) throughput and/or reduce (e.g., minimize) expected cost.

For embodiments directed at obfuscated concurrent ML model scheduling, for example, system 300 may operate in a manner similar in some respects to embodiments discussed above, with some differences that are discussed below. Of course, subject matter is not limited in scope to the particular examples discussed herein.

In implementations, front end 310 may receive inputs representative of ML models at IaaS front end API 311, wherein the shape and/or data of the input tensors may be unknown but the architecture of the ML models may be known. Further, in implementations, system 300 may comprise a set of available processing elements and/or memories, such as elements of compute unit 330 (e.g., CPU, GPU, NPU), including their corresponding secure enclaves.

System 300 may also determine and/or store a set of known, configured kernels that may operate relative to, and/or represent the computations of, compute nodes of a DAG, for example. In implementations, the binaries may be owned by users and as such may be treated as hidden/obfuscated to the scheduler, for example. In implementations, secure enclaves of the processing elements of compute unit 330 may notify scheduler 320, for example, when a particular hidden/obfuscated compute node is being executed. For example, a secure enclave may signal a unique compute node identifier to scheduler 320 and/or may provide hooks for triggering and/or responding to measurement requests from the scheduler. In implementations, the unique compute node identifier may comprise a hash value, although subject matter is not limited in scope in these respects.

As mentioned above in connection with compute unit 330, measurement instrumentation may be included to generate inference request statistics for contention estimation, in implementations. Example measurements may include, by way of non-limiting examples, compute latency, memory bandwidth, intermediate tensor memory footprint, time from last inference, etc. As further mentioned above, scheduler 320 may include one or more of contention guesstimator 325, scheduling queue 321 and/or dispatched compute nodes queue 322, for example. In implementations, contention guesstimator 325, scheduling queue 321 and/or dispatched compute nodes queue 322 may operation outside of an enclave. Of course, as mentioned, embodiments of system 300 and/or scheduler 320 may comprise arrangements of functional units that differ from that shown in FIG. 3, and subject matter is not limited in scope in these respects.

In implementations, rather than having multiple runtimes for individual mutually untrusting clients running in parallel in their own enclave (e.g., via threads or processes), a global queue owned by the IaaS provider may be utilized, through which one or more (e.g., relatively many) of a model's compute nodes may be scheduled intelligently. In implementations, an enclave may be created for individual processing element classes (e.g., CPU, GPU, NPU, etc.) available on the hardware of compute unit 330 to execute compute nodes. Such an enclave may be shared as an execution environment for individual clients of the system who provide their own models, for example.

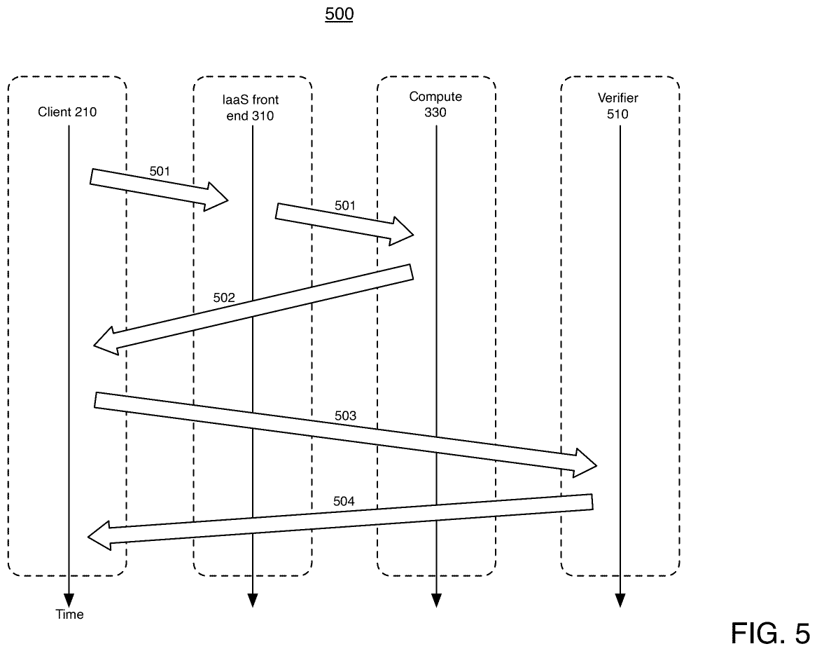

In implementations, an external attestation service may be utilized to authenticate to the client (e.g., client 210) that its software is, in-fact, running in a secure enclave on one or more processing elements of compute unit 330. For example, as depicted in FIG. 5, an example message flow diagram 500 may include an enclave provision request 501 transmitted from client 210 to IaaS front end 310 and further provided from IaaS front end 310 to IaaS backend, such as one or more processing elements of compute unit 330. In an implementation, the request may comprise an identifier. For example, request 501 may comprise a format of (provision request, nonce). Responsive at least in part to receiving request 501, compute unit 330 may provision an execution environment including the generation of a secure enclave.

As further indicated in example message flow diagram 500, compute unit 330 may generate a message 502 comprising a signed attestation token based at least in part on the nonce and/or parameters related to the provisioned execution environment. In implementations, the attestation may be signed by an asymmetric private key known only to compute element 330. Further, verifier 510 may know the associated public key, for example. In implementations, message 502 may comprise a format of hash (nonce, config). As indicated, message 502 may be provided from compute unit 330 to client 210. It may be noted that other possible attestation approaches may not require client 210 to issue the request to the verifier 510. For example, when a compute unit 330 enclave starts, compute unit 330 may send its attestation token to verifier 510, and verifier 510 may generate a “passport” (e.g., x.509 certificate) that may indicate that attestation has been accomplished correctly. Of course, subject matter is not limited in scope in these respects.

Additionally, responsive at least in part to client 210 obtaining the hash value via message 502, client 210 may generate an attestation validation request 503, wherein the attestation validation request comprises the attestation token generated by the IaaS backend. In implementations, an attestation token may comprise a measurement of software running inside a particular enclave so that relying parties, such as client 210, can be assured of the environment where their ML model(s) will be executed, for example. As depicted in example message flow 500, attestation validation request 503 may be provided to an external verification service 510. In implementations, verification service 510 may determine via any of a variety of approaches whether the execution environment provisioned in compute unit 330 is operating in a secure enclave. Responsive at least in part to a determination in the affirmative, verification service 510 may transmit a message 504 indicating a successful verification result. Of course, message flow diagram 500 is merely an example, and subject matter is not limited in scope in these respects.

In implementations, once the attestation process is complete, client 210 may generate a public-private key pair and may provide a copy of the private key to each shared secure enclave in system 300. Also, in implementations, the private key may be stored in a lookup table. In implementations, the private key may be stored in the lookup table indexed according to a client ID value, for example.

Further, in implementations, when a client 210 wishes to add a ML model to IaaS system 300, the weights of their model may be encrypted using an encrypted symmetric key. For example, a random symmetric key may be generated, and the random symmetric key may be encrypted with the generated public key. Also, for example, the ML model may be encrypted with the symmetric key. The encrypted ML model and the encrypted symmetric key may be provided to compute enclave 330, for example. In this mode of operation, scheduler 320 may be referred to as a “blind scheduler” or a “blinded optimizer.” Of course, subject matter is not limited in scope in these respects. In implementations, prior to issuing an inference request, client 210 may encrypt input data to accompany the inference request using the symmetric key, and may further attach a client ID to the request meta-data, for example. The encrypted input data may be delivered with the encrypted public key to front end 310, in implementations.

Responsive at least in part to receiving an inference request with a client ID attached, scheduler 320 (i.e., blinded optimizer) may commence dispatching compute nodes for processing in the shared secure enclaves, informed by the heuristics discussed above (e.g., contention estimates generated in accordance with example relation 1), for example. In implementations, within the secure enclaves where compute node (e.g., kernel) execution takes place, a client's private key may be utilized, at least in part, to decrypt the symmetric key. The decrypted symmetric key may be utilized to decrypt the weights and input data pertaining individual compute nodes prior to execution, in implementations.

In an alternate implementation, an attestation service may generate its own public/private key pair. Upon successful attestation for each of the secure enclaves in the IaaS platform, the generated private key may be distributed to individual clients 210. As part of an inference request, individual clients 210 may encrypt their respective private keys with the public key provided by the attestation service. Further, at ML model load time, a client's private key may be used to decrypt the symmetric key which may in turn by utilized to decrypt the model weights and input data within the secure enclaves. In implementations, the encrypted private key may be stored in the lookup table, for example.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

A “signal measurement” and/or a “signal measurement vector” may be referred to respectively as a “random measurement” and/or a “random vector,” such that the term “random” may be understood in context with respect to the fields of probability, random variables and/or stochastic processes. A random vector may be generated by having measurement signal components comprising one or more random variables. Random variables may comprise signal value measurements, which may, for example, be specified in a space of outcomes. Thus, in some contexts, a probability (e.g., likelihood) may be assigned to outcomes, as often may be used in connection with approaches employing probability and/or statistics. In other contexts, a random variable may be substantially in accordance with a measurement comprising a deterministic measurement value or, perhaps, an average measurement component plus random variation about a measurement average. The terms “measurement vector,” “random vector,” and/or “vector” are used throughout this document interchangeably. In an embodiment, a random vector, or portion thereof, comprising one or more measurement vectors may uniquely be associated with a distribution of scalar numerical values, such as random scalar numerical values (e.g., signal values and/or signal sample values), for example. Thus, it is understood, of course, that a distribution of scalar numerical values, for example, without loss of generality, substantially in accordance with the foregoing description and/or later description, is related to physical measurements, and is likewise understood to exist as physical signals and/or physical signal samples.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, 4G, or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

FIG. 6 is a schematic diagram illustrating an implementation of an example computing environment associated with processes to facilitate assigning, configuring and/or managing a particular hardware device, such as a ML accelerator and/or the like, according to an embodiment. In the example depicted in FIG. 6, a system embodiment may comprise a local network (e.g., device 604 and medium 640) and/or another type of network, such as a computing and/or communications network. For purposes of illustration, therefore, FIG. 6 shows an embodiment 600 of a system that may be employed to implement either type or both types of networks. Network 608 may comprise one or more network connections, links, processes, services, applications, and/or resources to facilitate and/or support communications, such as an exchange of communication signals, for example, between a computing device, such as 602, and another computing device, such as 606, which may, for example, comprise one or more client computing devices and/or one or more server computing device. By way of example, but not limitation, network 608 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 6 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device,” “processor” and/or similar terms; however, if it is determined, for some reason not immediately apparent, that the foregoing understanding cannot stand and that 35 USC § 112 (f), therefore, necessarily is implicated by the use of the term “computing device,” “processor” and/or similar terms, then, it is intended, pursuant to that statutory section, that corresponding structure, material and/or acts for performing one or more functions be understood and be interpreted to be described at least in FIGS. 1-5 and in the text associated with the foregoing figure(s) of the present patent application.

Referring now to FIG. 6, in an embodiment, first and third devices 602 and 606 may be capable of rendering a graphical user interface (GUI) for a network device and/or a computing device, for example, so that a user-operator may engage in system use. Device 604 may potentially serve a similar function in this illustration. Likewise, in FIG. 6, computing device 602 (‘first device’ in figure) may interface with computing device 604 (‘second device’ in figure), which may, for example, also comprise features of a client computing device and/or a server computing device, in an embodiment. Processor (e.g., processing device) 620 and memory 622, which may comprise primary memory 624 and secondary memory 626, may communicate by way of a communication bus 615, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 604, as depicted in FIG. 6, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as IOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 6, computing device 602 may provide one or more sources of executable computer instructions in the form physical states and/or signals (e.g., stored in memory states), for example. Computing device 602 may communicate with computing device 604 by way of a network connection, such as via network 608, for example. As previously mentioned, a connection, while physical, may not necessarily be tangible. Although computing device 604 of FIG. 6 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 622 may comprise any non-transitory storage mechanism. Memory 622 may comprise, for example, primary memory 624 and secondary memory 626, additional memory circuits, mechanisms, or combinations thereof may be used. Memory 622 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 622 may be utilized to store a program of executable computer instructions. For example, processor 620 may fetch executable instructions from memory and proceed to execute the fetched instructions. Memory 622 may also comprise a memory controller for accessing device readable-medium 640 that may carry and/or make accessible digital content, which may include code, and/or instructions, for example, executable by processor 620 and/or some other device, such as a controller, as one example, capable of executing computer instructions, for example. Under direction of processor 620, a non-transitory memory, such as memory cells storing physical states (e.g., memory states), comprising, for example, a program of executable computer instructions, may be executed by processor 620 and able to generate signals to be communicated via a network, for example, as previously described. Generated signals may also be stored in memory, also previously suggested.

Memory 622 may store electronic files and/or electronic documents, such as relating to one or more users, and may also comprise a computer-readable medium that may carry and/or make accessible content, including code and/or instructions, for example, executable by processor 620 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 6, processor 620 may comprise one or more circuits, such as digital circuits, to perform at least a portion of a computing procedure and/or process. By way of example, but not limitation, processor 620 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 604 as including a component 632 operable with input/output devices, for example, so that signals and/or states may be appropriately communicated between devices, such as device 604 and an input device and/or device 604 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

Embodiments may also be described, at least in part, by the following numbered clauses:
Clause 1. An apparatus, comprising: a forecaster circuit of an inference as a service (IaaS) system to generate a predicted timing distribution for a plurality of expected inference requests for a plurality of machine-learning (ML) models to be concurrently executed at the IaaS; a scheduler circuit of the IaaS to, responsive at least in part to one or more inference requests obtained from one or more clients, schedule execution of a plurality of compute nodes of a subset of the plurality of ML models based at least in part on the predicted timing distribution for the plurality of expected inference requests for the plurality of ML models.
Clause 2. The apparatus of clause 1, further comprising: a plurality of hardware processing elements; and a contention estimator circuit to, for a measurement mode of operation, generate one or more computational resource contention estimates pertaining to execution of the plurality of compute nodes of the subset of the plurality of ML models by one or more combinations of the plurality of hardware processing elements.
Clause 3. The apparatus of any of the preceding clauses, wherein, to schedule execution of the plurality of compute nodes of the subset of the plurality of ML models, the scheduler circuit to specify a priority order for the plurality of compute nodes of the subset of the plurality of ML models based at least in part on the one or more computational resource contention estimates.
Clause 4. The apparatus of any of the preceding clauses, wherein, to schedule execution of the plurality of compute nodes of the subset of the plurality of ML models, the scheduler unit is further to designate individual compute nodes of the plurality of compute nodes of the subset of the plurality of ML models for execution at a first combination of processing elements of the plurality of hardware processing elements based at least in part on the one or more computational resource contention estimates.
Clause 5. The apparatus of any of the preceding clauses, wherein the scheduler circuit comprises a priority queue to store the plurality of compute nodes of the subset of the plurality of ML models, and wherein, to specify the priority order for the plurality of compute nodes of the subset of the plurality of ML models, the scheduler circuit to store individual priority indicators for individual compute nodes of the plurality of compute nodes of the subset of the plurality of ML models.
Clause 6. The apparatus of any of the preceding clauses, wherein the forecaster circuit is further to: detect a timing pattern for the one or more inference requests obtained from the one or more clients that differs from the predicted timing distribution greater than a specified threshold amount; generate updated predicted timings pertaining to the predicted timing distribution for the plurality of expected inference requests based at least in part on the one or more inference requests obtained from the one or more clients; and provide the updated predicted timings pertaining to the predicted timing distribution for the plurality of expected inference requests to the schedular circuit.
Clause 7. The apparatus of any of the preceding clauses, wherein: responsive to the updated predicted timings, the contention estimator circuit is to enter the measurement mode of operation and to regenerate the one or more computational resource contention estimates pertaining to the execution of the plurality of compute nodes of the subset of the plurality of ML models by the one or more combinations of the plurality of hardware processing elements; and the scheduler circuit is to: reorder the priority order for the plurality of compute nodes of the subset of the plurality of ML models based at least in part on the updated predicted timings pertaining to the predicted timing distribution; and designate the individual compute nodes of the plurality of compute nodes of the subset of the plurality of ML models for execution at a second combination of processing elements of the plurality of hardware processing elements based at least in part on the one or more regenerated computational resource contention estimates.
Clause 8. The apparatus of any of the preceding clauses, further comprising an IaaS front end including: the forecaster circuit; an application programming interface (API) by which the one or more clients may provide the plurality of inference requests; and a model database to store the plurality of ML models and further to store weight parameters and access statistical parameters for individual ML models of the plurality of models.
Clause 9. The apparatus of any of the preceding clauses, wherein the IaaS front end is to provide to the scheduler circuit the plurality of inference requests and is further to provide to the scheduler circuit signals and/or states representative of: the subset of the plurality of ML models; the weight parameters to pertain to the subset of the plurality of ML models; and the predicted timing distribution.
Clause 10. The apparatus of any of the preceding clauses, wherein the subset of the plurality of ML models comprises at least two ML models of the plurality of ML models, wherein a first subset of the plurality of inference requests are to pertain to a first ML model of the subset of the plurality of ML models, and wherein a second subset of the plurality of inference requests are to pertain to a second ML model of the subset of the plurality of ML models.
Clause 11. The apparatus any of the preceding clauses, wherein the generated one or more computational resource contention estimates are stored in a contention estimator cache, wherein individual entries of the contention estimator cache comprise one or more contention estimates pertaining to execution of particular groupings of compute nodes by particular combinations of the plurality of hardware processing elements, and wherein a number of contention estimates per individual grouping of the particular groupings is variable in accordance with a specified resolution.
Clause 12. The apparatus of any of the preceding clauses, wherein, to schedule execution of the plurality of compute nodes of the subset of the plurality of ML models, the scheduler circuit is to perform a similarity search and/or a nearest neighbors search of the individual entries of the contention estimator cache and to specify a priority order for the plurality of compute nodes of the subset of the plurality of ML models based at least in part on one or more first contention estimates pertaining to one or more first groupings of the particular groupings to be determined via the similarity search and/or the nearest neighbor search.
Clause 13. A method, comprising: generating, by a forecaster circuit of an inference as a service (IaaS) system, a predicted timing distribution for a plurality of expected inference requests for a plurality of machine-learning (ML) models to be concurrently executed at the IaaS system; and responsive at least in part to one or more inference requests obtained from one or more clients, scheduling, by a scheduler circuit of the IaaS system, execution of a plurality of compute nodes of a subset of the plurality of ML models based at least in part on the predicted timing distribution for the plurality of expected inference requests for the plurality of ML models.
Clause 14. The method of clause 13, further comprising generating, by a contention estimator circuit for a measurement mode of operation, one or more computational resource contention estimates pertaining to execution of the plurality of compute nodes of the subset of the plurality of ML models by one or more combinations of a plurality of hardware processing elements of the IaaS system; wherein scheduling, by the scheduler circuit, execution of the plurality of compute nodes of the subset of the plurality of ML models includes: specifying a priority order for the plurality of compute nodes of the subset of the plurality of ML models based at least in part on the one or more computational resource contention estimates; and designating individual compute nodes of the plurality of compute nodes of the subset of the plurality of ML models for execution at a first combination of processing elements of the plurality of hardware processing elements based at least in part on the one or more computational resource contention estimates.
Clause 15. The method of any of clauses 13-14, further comprising: detecting, by the forecaster circuit, a timing pattern for the one or more inference requests obtained from the one or more clients that differs from the predicted timing distribution greater than a specified threshold amount; generating updated predicted timings pertaining to the predicted timing distribution for the plurality of expected inference requests based at least in part on the one or more inference requests obtained from the one or more clients; providing the updated predicted timings pertaining to the predicted timing distribution for the plurality of expected inference requests to the schedular circuit; responsive at least in part to the updated predicted timings, entering the measurement mode of operation and regenerating the one or more computational resource contention estimates pertaining to the execution of the plurality of compute nodes of the plurality of ML models by the one or more combinations of the plurality of hardware processing elements; reordering, by the scheduler circuit, the priority order for the plurality of compute nodes of the subset of the plurality of ML models based at least in part on the updated predicted timings; and designating, by the scheduler circuit, the individual compute nodes of the plurality of compute nodes of the subset of the plurality of ML models for execution at a second combination of processing elements of the plurality of hardware processing elements based at least in part on the one or more regenerated computational resource contention estimates.
Clause 16. The method of any of clauses 13-15, wherein the IaaS system comprises a front end including the forecaster circuit, an application programming interface (API), and a model database, wherein the method further comprises: receiving the plurality of inference requests from the one or more clients; storing the plurality of ML models in the model database; and storing weight parameters and access statistical parameters for individual ML models of the plurality of models in the model database.
Clause 17. The method of any of clauses 13-16, further comprising: providing, from the IaaS front end to the scheduler circuit, the plurality of inference requests; and providing, from the IaaS front end to the scheduler circuit, signals and/or states representative of: the subset of the plurality of ML models; the weight parameters to pertain to the subset of the plurality of ML models; and the predicted timing distribution.
Clause 18. The method of any of clauses 13-17, wherein the subset of the plurality of ML models comprises at least two ML models of the plurality of ML models, wherein a first subset of the plurality of inference requests pertain to a first ML model of the subset of the plurality of ML models, and wherein a second subset of the plurality of inference requests pertain to a second ML model of the subset of the plurality of ML models.
Clause 19. An article, comprising: a non-transitory computer-readable medium having stored thereon one or more instructions executable by one or more computing devices of an IaaS system to: generate a predicted timing distribution for a plurality of expected inference requests for a plurality of machine-learning (ML) models to be concurrently executed at the IaaS system; and responsive at least in part to one or more inference requests obtained from one or more clients, schedule execution of a plurality of compute nodes of a subset of the plurality of ML models based at least in part on the predicted timing distribution for the plurality of expected inference requests for the plurality of ML models.
Clause 20. The article of clause 19, wherein the computer-readable medium has stored thereon further instructions executable by the one or more computing devices of the IaaS system to: generate, for a measurement mode of operation, one or more computational resource contention estimates pertaining to execution of the plurality of compute nodes of the subset of the plurality of ML models by one or more combinations of a plurality of hardware processing elements of the IaaS system; wherein, to schedule execution of the plurality of compute nodes of the subset of the plurality of ML models, one or more computing devices of the IaaS system are further to: specify a priority order for the plurality of compute nodes of the subset of the plurality of ML models based at least in part on the one or more computational resource contention estimates; and designate individual compute nodes of the plurality of compute nodes of the subset of the plurality of ML models for execution at a first combination of processing elements of the plurality of hardware processing elements based at least in part on the one or more computational resource contention estimates.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. An apparatus, comprising:
a forecaster circuit of an inference as a service (IaaS) system to generate a predicted timing distribution for a plurality of expected inference requests for a plurality of machine-learning (ML) models to be concurrently executed at the IaaS;
a scheduler circuit of the IaaS to, responsive at least in part to one or more inference requests obtained from one or more clients, schedule execution of a plurality of compute nodes of a subset of the plurality of ML models based at least in part on the predicted timing distribution for the plurality of expected inference requests for the plurality of ML models.

2. The apparatus of claim 1, further comprising:
a plurality of hardware processing elements; and
a contention estimator circuit to, for a measurement mode of operation, generate one or more computational resource contention estimates pertaining to execution of the plurality of compute nodes of the subset of the plurality of ML models by one or more combinations of the plurality of hardware processing elements.

3. The apparatus of claim 2, wherein, to schedule execution of the plurality of compute nodes of the subset of the plurality of ML models, the scheduler circuit to specify a priority order for the plurality of compute nodes of the subset of the plurality of ML models based at least in part on the one or more computational resource contention estimates.

4. The apparatus of claim 3, wherein, to schedule execution of the plurality of compute nodes of the subset of the plurality of ML models, the scheduler unit is further to designate individual compute nodes of the plurality of compute nodes of the subset of the plurality of ML models for execution at a first combination of processing elements of the plurality of hardware processing elements based at least in part on the one or more computational resource contention estimates.

5. The apparatus of claim 3, wherein the scheduler circuit comprises a priority queue to store the plurality of compute nodes of the subset of the plurality of ML models, and wherein, to specify the priority order for the plurality of compute nodes of the subset of the plurality of ML models, the scheduler circuit to store individual priority indicators for individual compute nodes of the plurality of compute nodes of the subset of the plurality of ML models.

6. The apparatus of claim 3, wherein the forecaster circuit is further to:
detect a timing pattern for the one or more inference requests obtained from the one or more clients that differs from the predicted timing distribution greater than a specified threshold amount;
generate updated predicted timings pertaining to the predicted timing distribution for the plurality of expected inference requests based at least in part on the one or more inference requests obtained from the one or more clients; and
provide the updated predicted timings pertaining to the predicted timing distribution for the plurality of expected inference requests to the schedular circuit.

7. The apparatus of claim 6, wherein:
responsive to the updated predicted timings, the contention estimator circuit is to enter the measurement mode of operation and to regenerate the one or more computational resource contention estimates pertaining to the execution of the plurality of compute nodes of the subset of the plurality of ML models by the one or more combinations of the plurality of hardware processing elements; and
the scheduler circuit is to:
reorder the priority order for the plurality of compute nodes of the subset of the plurality of ML models based at least in part on the updated predicted timings pertaining to the predicted timing distribution; and
designate the individual compute nodes of the plurality of compute nodes of the subset of the plurality of ML models for execution at a second combination of processing elements of the plurality of hardware processing elements based at least in part on the one or more regenerated computational resource contention estimates.

8. The apparatus of claim 1, further comprising an IaaS front end including:
the forecaster circuit;
an application programming interface (API) by which the one or more clients may provide the plurality of inference requests; and
a model database to store the plurality of ML models and further to store weight parameters and access statistical parameters for individual ML models of the plurality of models.

9. The apparatus of claim 8, wherein the IaaS front end is to provide to the scheduler circuit the plurality of inference requests and is further to provide to the scheduler circuit signals and/or states representative of:
the subset of the plurality of ML models;
the weight parameters to pertain to the subset of the plurality of ML models; and
the predicted timing distribution.

10. The apparatus of claim 1, wherein the subset of the plurality of ML models comprises at least two ML models of the plurality of ML models, wherein a first subset of the plurality of inference requests are to pertain to a first ML model of the subset of the plurality of ML models, and wherein a second subset of the plurality of inference requests are to pertain to a second ML model of the subset of the plurality of ML models.

11. The apparatus of claim 2, wherein the generated one or more computational resource contention estimates are stored in a contention estimator cache, wherein individual entries of the contention estimator cache comprise one or more contention estimates pertaining to execution of particular groupings of compute nodes by particular combinations of the plurality of hardware processing elements, and wherein a number of contention estimates per individual grouping of the particular groupings is variable in accordance with a specified resolution.

12. The apparatus of claim 11, wherein, to schedule execution of the plurality of compute nodes of the subset of the plurality of ML models, the scheduler circuit is to perform a similarity search and/or a nearest neighbors search of the individual entries of the contention estimator cache and to specify a priority order for the plurality of compute nodes of the subset of the plurality of ML models based at least in part on one or more first contention estimates pertaining to one or more first groupings of the particular groupings to be determined via the similarity search and/or the nearest neighbor search.

13. A method, comprising:
generating, by a forecaster circuit of an inference as a service (IaaS) system, a predicted timing distribution for a plurality of expected inference requests for a plurality of machine-learning (ML) models to be concurrently executed at the IaaS system; and
responsive at least in part to one or more inference requests obtained from one or more clients, scheduling, by a scheduler circuit of the IaaS system, execution of a plurality of compute nodes of a subset of the plurality of ML models based at least in part on the predicted timing distribution for the plurality of expected inference requests for the plurality of ML models.

14. The method of claim 13, further comprising generating, by a contention estimator circuit for a measurement mode of operation, one or more computational resource contention estimates pertaining to execution of the plurality of compute nodes of the subset of the plurality of ML models by one or more combinations of a plurality of hardware processing elements of the IaaS system;
wherein scheduling, by the scheduler circuit, execution of the plurality of compute nodes of the subset of the plurality of ML models includes:
specifying a priority order for the plurality of compute nodes of the subset of the plurality of ML models based at least in part on the one or more computational resource contention estimates; and
designating individual compute nodes of the plurality of compute nodes of the subset of the plurality of ML models for execution at a first combination of processing elements of the plurality of hardware processing elements based at least in part on the one or more computational resource contention estimates.

15. The method of claim 14, further comprising:
detecting, by the forecaster circuit, a timing pattern for the one or more inference requests obtained from the one or more clients that differs from the predicted timing distribution greater than a specified threshold amount;
generating updated predicted timings pertaining to the predicted timing distribution for the plurality of expected inference requests based at least in part on the one or more inference requests obtained from the one or more clients;
providing the updated predicted timings pertaining to the predicted timing distribution for the plurality of expected inference requests to the schedular circuit;
responsive at least in part to the updated predicted timings, entering the measurement mode of operation and regenerating the one or more computational resource contention estimates pertaining to the execution of the plurality of compute nodes of the plurality of ML models by the one or more combinations of the plurality of hardware processing elements;
reordering, by the scheduler circuit, the priority order for the plurality of compute nodes of the subset of the plurality of ML models based at least in part on the updated predicted timings; and
designating, by the scheduler circuit, the individual compute nodes of the plurality of compute nodes of the subset of the plurality of ML models for execution at a second combination of processing elements of the plurality of hardware processing elements based at least in part on the one or more regenerated computational resource contention estimates.

16. The method of claim 13, wherein the IaaS system comprises a front end including the forecaster circuit, an application programming interface (API), and a model database, wherein the method further comprises:
receiving the plurality of inference requests from the one or more clients;
storing the plurality of ML models in the model database; and
storing weight parameters and access statistical parameters for individual ML models of the plurality of models in the model database.

17. The method of claim 16, further comprising:
providing, from the IaaS front end to the scheduler circuit, the plurality of inference requests; and
providing, from the IaaS front end to the scheduler circuit, signals and/or states representative of:
the subset of the plurality of ML models;
the weight parameters to pertain to the subset of the plurality of ML models; and
the predicted timing distribution.

18. The method of claim 13, wherein the subset of the plurality of ML models comprises at least two ML models of the plurality of ML models, wherein a first subset of the plurality of inference requests pertain to a first ML model of the subset of the plurality of ML models, and wherein a second subset of the plurality of inference requests pertain to a second ML model of the subset of the plurality of ML models.

19. An article, comprising: a non-transitory computer-readable medium having stored thereon one or more instructions executable by one or more computing devices of an IaaS system to:
generate a predicted timing distribution for a plurality of expected inference requests for a plurality of machine-learning (ML) models to be concurrently executed at the IaaS system; and
responsive at least in part to one or more inference requests obtained from one or more clients, schedule execution of a plurality of compute nodes of a subset of the plurality of ML models based at least in part on the predicted timing distribution for the plurality of expected inference requests for the plurality of ML models.

20. The article of claim 19, wherein the computer-readable medium has stored thereon further instructions executable by the one or more computing devices of the IaaS system to:
generate, for a measurement mode of operation, one or more computational resource contention estimates pertaining to execution of the plurality of compute nodes of the subset of the plurality of ML models by one or more combinations of a plurality of hardware processing elements of the IaaS system;
wherein, to schedule execution of the plurality of compute nodes of the subset of the plurality of ML models, one or more computing devices of the IaaS system are further to:
specify a priority order for the plurality of compute nodes of the subset of the plurality of ML models based at least in part on the one or more computational resource contention estimates; and
designate individual compute nodes of the plurality of compute nodes of the subset of the plurality of ML models for execution at a first combination of processing elements of the plurality of hardware processing elements based at least in part on the one or more computational resource contention estimates.
